(19) United States
(12) Patent Application Publication
(10) Pub. No.: US 2013/0108768 A1
(43) Pub. Date: May 2, 2013

(54) REDUCED-CALORIE PARTIALLY FROZEN BEVERAGES

(71) Applicant: Adrian Sepcic, Frisco, TX (US)

(72) Inventor: Adrian Sepcic, Frisco, TX (US)

(21) Appl. No.: 13/286,968

(22) Filed: Nov. 1, 2011

(51) Int. Cl. A23L 2/60; A23L 1/09

(52) U.S. Cl. 426/590

(57) ABSTRACT

Reduced-calorie partially frozen beverages may include erythritol, sucralose and a sugar component and may provide taste comparable to a full-calorie beverage. Sugars added in the reduced-calorie partially frozen beverage may be reduced between about 20% to about 40% by weight as compared to a full-calorie beverage. Erythritol and sucralose may be added at levels to offset sweetness reduction afforded by the reduced sugar content.

### FIELD

The present application relates to reduced-calorie partially frozen beverages that have taste characteristics similar to those of full-calorie partially frozen beverages and to mixes or syrups that may be used in the production of such beverages.

### BACKGROUND

Diet or reduced-calorie versions of products that are typically sweet may have reduced sugar content, and therefore a lowered contribution of sweetness afforded from caloric sugars. To raise the sweetness level, reduced-calorie products may substitute another sweetening component to compensate for the lack of sugar, e.g., such products may contain high-intensity sweeteners, non-nutritive sweeteners, or combinations thereof. Unfortunately, according to many consumers, such sweeteners, individually or in combination, do not impart exactly the same taste as natural sugars, and such consumers may experience negative taste characteristics of consumable items that include those sweeteners. Negative attributes associated with such consumable items may include but are not limited to a lack of upfront sweetness, lingering sweetness, and a lack of overall flavor. Additionally, the general mouthfeel of reduced-calorie consumable items may suffer in the absence of the syrup-like feel or texture that is associated with sugars. In pure liquid beverages, attempts to overcome such concerns have been only partially successful.

In partially frozen beverages, such as slush products, sugars not only provide sweetness and mouthfeel, they also provide a solute concentration that lowers the freezing point of the product. Lowering the freezing point of a partially frozen beverage may assist in making a product compatible with conventional machines designed for their manufacture, which typically operate at temperatures that are several degrees below the freezing point of pure water. Without proper control of the freezing point and kinetics of the phase transformation, a composition may change phase in an undesirable manner, e.g., it may experience rapid and uncontrolled freezing. In some cases, rapid freezing may damage production machinery because, for example, significant fractions of ice may collect on machinery components. Moreover, uncontrolled freezing may impact the relative distribution and size of ice particles in a slush beverage, and such may, for example, affect various attributes of a food product including, among other attributes, mouthfeel, flavor, sweetness, the retention of carbon dioxide and overall texture.

Therefore, production of reduced-calorie frozen or partially frozen products have additional concerns above those in pure liquid systems, and to date production of reduced-calorie partially frozen beverages that provide taste characteristics similar to full-calorie partially frozen beverages have not been achieved satisfactorily. In light of the foregoing, it would be beneficial to provide a diet or reduced-calorie syrup or mix capable of undergoing controlled phase transition and which provides a reduced-calorie partially frozen beverage with desirable taste characteristics.

### SUMMARY

In some embodiments, reduced-calorie partially frozen beverages include erythritol, sucralose, and a sugar component. Such reduced-calorie beverages may have about 20% to about 50% less calories than conventional full-calorie partially frozen beverages. In some embodiments, the total soluble solids content of a beverage may be between about 8-15% by weight, and may include erythritol, a natural-caloric sugar, sucralose, and flavoring agents. In some embodiments, the freezing point of a reduced-calorie partially frozen beverage may be between about 26° F. to about 30.2° F., or between about 28° F. to about 30° F., or between about 29° F. to about 29.8° F.

### BRIEF DESCRIPTION OF THE DRAWINGS

FIG. 1 is a graph showing sweetness of a reduced-calorie partially frozen beverage as compared to a full-calorie partially frozen beverage as evaluated by a trained sensory panel.

FIG. 2 is a graph showing flavor characteristics of a reduced-calorie partially frozen beverage as compared to a full-calorie partially frozen beverage as evaluated by a trained sensory panel.

### DETAILED DESCRIPTION

The following terms as used herein should be understood to have the indicated meanings

When an item is introduced by “a” or “an,” it should be understood to mean one or more of that item.

“Comprises” means includes but is not limited to.

“Comprising” means including but not limited to.

“Having” means including but not limited to.

The term “beverage” as used herein means any drinkable liquid or semi-liquid, including for example flavored water, soft drinks, fruit drinks, slush products, smoothies, coffee-based drinks, tea-based drinks, juice-based drinks, milk-based drinks, gel drinks, carbonated or non-carbonated drinks, alcoholic or non-alcoholic drinks

The term “consumable item” means anything that may be orally ingested by a consumer, including without limitation a food, beverage, pharmaceutical composition, nutraceutical composition, vitamin, lozenge, dietary supplement, confection, chewing gum, candy and a combination of any of the foregoing.

The term “high-potency sweetener” means any ingredient that initiates a perception of sweetness at a concentration less than that which would be required for a natural-caloric sweetener. High-potency sweeteners may include by way of example acesulfame-K, aspartame, saccharin, stevia, sucralose, and combinations thereof.

The term “partially frozen” means a state that includes a proportion of ice crystals. Some food products that may be consumed in a partially frozen state include but are not limited to materials commonly referred to as “smoothies,” “slurpees,” and “slush” products.

The term “intensity of a sweetener” means the rate of change of sweetness level as the concentration of the sweetener is changed.

This disclosure is directed to reduced-calorie partially frozen beverages that include erythritol, sucralose, and a sugar component as well as syrups or mixes that may be used in production of such reduced-calorie partially frozen beverages. In some embodiments, partially frozen beverages described herein may have reduced-calorie content and yet have properties similar to those exhibited by full-calorie partially frozen beverages.

In some embodiments, a reduced-calorie partially frozen beverage may be compatible with conventional machinery designed to create a partially frozen beverage, such as, for example, beverages commonly referred to as “slush products” or “slurpees.” A reduced-calorie partially frozen beverage may include a solute concentration to depress the freezing point below that of pure water. For example, the freezing point of a reduced-calorie partially frozen beverage may be between about 29° F. to about 29.8° F., about 28° F. to about 30° F., or about 26° F. to about 30.2° F. The lowering of the freezing point may be related to the number of solute molecules in solution, that is, it may be roughly proportional to the number of solutes in a given volume. The proportionality of the freezing point depression and the number of solute molecules is an approximation, and may hold closely for systems where solute-solvent interactions are low. For example, the level of freezing depression and thus the temperature at which a mix may change phase, may, to a first approximation, be described using the equation

ΔTf=KfMi

where ΔTf is the freezing point depression, Kf is the cryoscopic constant (which is related to the solvent and which for water has a value of about 1.85 K·kg/mol), M is the molality of solution, and i is the Vant Hoff factor (which relates to the number of particles per mole of dissolved solute). The molecular weight ratio of erythritol to the molecular weight of fructose (or glucose) is about 2:3. Therefore, substitution in a partially frozen beverage of a certain weight of glucose or fructose with an equivalent weight of erythritol may result in about 1.5 times the number of molecules in solution. Thus, for a given mass, substitution of erythritol may, to a first approximation, be expected to provide about 1.5 times the freezing depression that the equivalent mass of fructose or glucose might provide. For sucrose, which has a higher molecular weight than glucose or fructose, substitution of a given mass of erythritol may be expected to provide about 2.8 times the freezing depression as would the equivalent mass of sucrose.

For a syrup or mix, i.e., for use in forming a partially frozen beverage, the freezing point may be one factor in determining the quality of the resultant partially frozen beverage, and as described above the freezing point is to a first approximation determined by the number of solute particles in solution. However, various other properties of solutes, e.g., in addition to the number of solute molecules, may influence not only the freezing point but also the kinetics of the phase transformation, and such may also influence product quality. For example, as a syrup or mix is cooled, i.e., for production of a partially frozen beverage, such as to initiate formation of ice crystals, the homogeneity of the composition may change. Solutes may, for example, be confined to liquid regions of the phase transforming mix, and as the remaining liquid volume of the mix drops, a significant increase in local solute concentration may occur, e.g., around forming ice crystals. Thus, as the free volume of liquid changes, the local concentration of solutes as well as the local viscosity of solution surrounding ice crystals may be altered. Ice crystals which initially form as the solution begins to freeze, i.e., nucleation sites, may grow, and such growth may be related to water molecules which diffuse to the boundary of the crystal. Use of solute concentration and solutes that retard the diffusion of water may favor the formation of new nucleation sites as opposed to the growth of existing ice crystals. For example, an increase in viscosity of the remaining liquid phase of a mix that is experiencing a phase transformation may hinder crystallization and promote nucleation of additional crystal sites as opposed to growth of existing ice crystals.

Thus, the kinetics of phase transformation of a mix or syrup, i.e., for production of a reduced-calorie partially frozen beverage, may affect the size distribution of ice particles that may form and may also impact various properties that influence consumer acceptance of the partially frozen beverage, including, by way of non-limiting example, the partially frozen beverage's texture, mouthfeel, sweetness, level of carbonation, and the uniformity of the product as a consumer begins to consume the beverage. Moreover, the particle size may influence how those properties may change during consumption, e.g., as a partially frozen beverage melts, because, for example, the rate of melting may be related, at least in part, to the surface area of ice particles.

In some embodiments, solutes, e.g., of a certain concentration and viscosity, may be used to optimize the texture or mouthfeel of a reduced-calorie partially frozen beverage that may be consumed immediately after production. In some embodiments, solutes may be selected to optimize the texture or mouthfeel of a reduced-calorie partially frozen beverage that may be consumed after a period of time following production of the beverage. In some embodiments, solutes may be selected to adjust not only the sweetness of a beverage but also changes in sweetness that may occur as the beverage melts. That is, because some solutes may also be sweeteners, the sweetness of a partially frozen beverage may depend upon the time after production and temperature in which the product is consumed, and, for example, whether a significant fraction of initially solid ice crystals may have melted.

In some embodiments, a reduced-calorie partially frozen beverage may have a reduced amount of added sugar when compared to a full-calorie partially frozen beverage and may augment the composition's sweetness by addition of sucralose and erythritol. Sucralose is a compound of very high sweetness and may be added, in some embodiments, at about 10 to about 50 ppm, or about 20 ppm to about 42 ppm, or about 30 ppm to about 40 ppm, or about 35 ppm. In general, the concentration of sucralose may be much smaller than added erythritol and may play only a minor role in determining the freezing point of a partially frozen beverage.

Erythritol is a small molecule, polyol, that provides only a few calories. While providing some sweetness, erythritol has much lower sweetness intensity than sucralose. Thus, erythritol may be added at significantly higher concentrations than sucralose. In some embodiments, erythritol may be included in a partially frozen beverage at between about 0.1 to about 3.0 weight percent, or about 1.0 to about 2.0 weight percent, or about 1.4 to about 1.6 weight percent. In some embodiments, solutes may be added at levels sufficient to depress the freezing point of an aqueous mix or syrup by about 1.8° C. to about 6.0° C. In some embodiments, a composition used to make a reduced-calorie partially frozen beverage may contain a total of about 8% to about 14% by weight soluble solids. The weight fraction of soluble solids that are provided from erythritol may, in some embodiments, be up to about 30%.

In some embodiments, partially frozen beverages described herein may have reduced-calorie content and yet have properties similar to those exhibited by full-calorie, partially frozen beverages. In some embodiments, a sugar component may be added at a level that is reduced about 20% to about 40%, or about 25% to about 35%, or about 30% as compared to the amount of sugar in a full-calorie partially frozen beverage. Sucrose may be an added sugar in a partially frozen beverage. Some partially frozen beverages made with sucrose, may, for example, contain about 10° Bx. A 10° Bx solution of sucrose, e.g., with about 10 grams of sucrose per 100 grams of solution, contains for each 100 grams of solution about 29 millimoles of sucrose. A partially frozen beverage may also comprise monosaccharide sugars such as, for example, fructose and glucose. For example, a 10% solids solution prepared from HFCS 55, e.g., with a distribution of sugars in a ratio of about 55% fructose and about 42% glucose, may contain about 10 grams of sugar per 100 grams of solution. However, the molecular weight of fructose (and glucose) is about 1.9 fold less than sucrose, and thus, the 10% solids solution of HFCS 55 may contain, for each 100 grams of solution, about 55 millimoles of sugar, a significantly greater number of molecules than the above sucrose solution. The two solutions, e.g., of sucrose and of fructose and glucose, may exhibit only small differences in sweetness but contain a much different number of particles.

Thus, a sweetened solution of sugar water, e.g., that has the same sweetness as a full-calorie partially frozen beverage, may, if that sugar is sucrose, comprise less total molecules than if the sugar comprises a ratio of sugars, e.g., of about 55% fructose and about 42% glucose, e.g., as may be found with some high fructose corn syrups. Therefore, the freezing point of such a sweetened solution of high fructose corn syrup may be lower than that of a corresponding sucrose solution. For reduced-calorie partially frozen beverages, e.g., sweetened with combinations of glucose and fructose, such may be advantageous, because, for example, an ideal freezing point, e.g., acceptable level of freezing depression, may be achieved while adding a lower amount of other solutes to compensate for the reduced sugar content.

In some embodiments, a reduced-calorie partially frozen beverage may provide for a 12 oz portion between about 100 calories to about 140 calories, about 110 calories to about 130 calories, or about 120 calories. In some embodiments, the sugar component in a reduced-calorie partially frozen beverage may be provided in the form of corn syrup that has been treated to convert a fraction of glucose into fructose. For example, natural-caloric sweeteners may be provided as a mixture of about 55% fructose and about 42% glucose, which is commonly referred to as HFCS 55, or may be provided as a mixture of about 42% fructose and about 53% glucose, which is commonly referred to as HFCS 42. Other sweeteners, including those with different distributions of fructose and glucose, may also be used. In some embodiments, the sugar component comprises a high fructose corn syrup present at a solids concentration of about 7.5° Bx to about 10° Bx.

In some embodiments, glucose, or another monosaccharide that is less sweet than fructose, may be added to a beverage that is sweetened with fructose, such that a ratio of fructose to other monosaccharides is achieved, and the sugars in the beverage may be subject to constraints wherein the beverage total sweetness, upon addition of between about 1.2% to about 1.8% erythritol and no more than 40 ppm sucralose, is close to that of a full-calorie beverage, and the freezing point of the beverage is between about 28° F. to about 30° F. In some embodiments, the sugar component of a reduced-calorie partially frozen beverage may consist of monosaccharides, and may, for example, be substantially free of sucrose. In some embodiments, a sugar component may consist of glucose and fructose present at concentrations to provide a solids content of about 7.5° Bx to about 10° Bx.

In some embodiments, it may be desirable to select the sugar component of a reduced-calorie partially frozen beverage to influence the resultant particle size of a partially frozen beverage. In some embodiments, a reduced-calorie partially frozen beverage may comprise less than about 2% by weight erythritol, at least one high potency sweetener, and may contain a sugar component comprising glucose and fructose. In some embodiments, a reduced-calorie partially frozen beverage may comprise less than about 2% by weight erythritol, at least one high potency sweetener, and may contain a sugar component comprising fructose and one or more monosaccharides of lower sweetness than fructose. In some embodiments, a reduced-calorie partially frozen beverage may comprise less than about 2% by weight erythritol, at least one high potency sweetener, and may contain a sugar component consisting of monosaccharides.

Reduced-calorie partially frozen beverages described in this disclosure may, in some embodiments, have a similar taste to full-calorie partially frozen beverages. The taste characteristics of reduced-calorie partially frozen beverages may, in some embodiments, be similar to full-calorie beverages because of the suppression of at least one negative characteristic commonly associated with other beverages designed with lower calorie content than full-calorie consumables. By way of non-limiting example, some negative characteristics commonly associated with other lower calorie content beverages may include inadequate overall sweetness, excessive overall sweetness, lacking upfront sweetness, lingering sweetness, lacking overall flavor, a sweetness that reduces with repetitive tasting, having limited or improper mouthfeel, having off-taste properties such as bitter, metallic or licorice-like aftertaste, and combinations of the foregoing.

Sweeteners included in a partially frozen beverage may influence the above mentioned negative characteristics of other diet beverages in various ways. Sweeteners included in partially frozen consumable items may be used in controlled amounts and proportions in order to optimize the taste characteristics of a partially frozen beverage. The influence of sweeteners on negative characteristics may be directly attributed to stimulation of sweetness receptors in the oral cavity, such as is the case, for example, in inadequate overall sweetness or lacking upfront sweetness, or may be related to the sweeteners indirectly, such as may be the case for negative characteristics including, for example, improper mouthfeel, lacking overall flavor, or having off-taste properties. In general, the sweetness properties associated with natural sugars are most appealing, and attempts may be made in some embodiments of reduced-calorie consumable items to match the properties of natural sugars. A description of the properties of natural sugar or of a sweetener in general may include the sweetness level which characterizes the magnitude in which a consumer perceives the property of sweetness. A description of a sweetener may also include how the perception of sweetness varies as a function of time, including sweetness perception immediately after sampling a consumable item and at other time points following consumption. A description of a sweetener may also include the level of sweetness perceived for the entire oral cavity or with different values in individual regions of the oral cavity, such as regions of the oral cavity where an individual may chew on ice particles. In addition to providing adequate levels of the perception of sweetness, sweetener combinations described herein may be made that match the time dependence of natural sugars, the spatial dependence of natural sugars, or both. In some embodiments, sweeteners that match the sweetness level, time dependence, or spatial dependence of natural sugar, at the concentration of a full-calorie partially frozen consumable item, may suppress negative characteristics commonly associated with consumable items of lower calorie content.

Some of the aforementioned characteristics of consumables may be related to the temperature at which they are consumed. Furthermore, partially frozen beverages may be chewed and sucked on during consumption. Those beverages may be held in the mouth for a significantly longer period of time than non-frozen beverages. Therefore, the consumption of some partially frozen beverages and the stimulation of oral receptors, including for example sweetness receptors, may be more persistent than for non-frozen beverages. Persistent stimulation of receptors may impact the aforementioned negative characteristics of reduced-calorie sweeteners in various ways. For example, in some embodiments partially frozen beverages may include sweetener systems designed to minimize off-taste characteristics, excessive sweetness or the reduction of sweetness with repetitive tasting. For example, sucralose is a high potency sweetener that upon consumption provides a perception of sweetness that is more similar to natural sugar than some other high potency sweeteners. Furthermore, sucralose shows better resilience to repetitive tasting than other high potency sweeteners. Such is one nonlimiting reason that sucralose may be ideally suited for beverages, such as those that are partially frozen, where the residency time in the mouth may be longer than in other beverages.

When used at concentrations commonly found in full-calorie partially frozen beverages, natural sugars may provide a high level of sweetness. In this respect, one may differentiate the level of sweetness that may be achieved with a sweetener from the intensity of the sweetener. In comparison to natural sugars, some high-intensity sweeteners may show a more rapid increase in sweetness with increasing concentration in ranges where the sweetener is used in relatively low amounts. This behavior may not hold at higher concentrations, and the maximum sweetness level that may be achieved with high-intensity sweeteners may not be as high as that of natural sugar. In some embodiments, a combination of sweeteners may be used in a reduced-calorie partially frozen consumable item that provides a level of sweetness comparable to that of a full-calorie partially frozen consumable item but providing significantly lower calorie content.

In some embodiments, a reduced-calorie partially frozen beverage may be a carbonated beverage, and may include a combination of sucralose, erythritol and a natural sugar. Solutes may in some embodiments serve to facilitate phase change during freezing and stabilize carbon dioxide during production of a reduced-calorie partially frozen carbonated beverage.

In some embodiments, a reduced-calorie partially frozen beverage may include the addition of propylene glycol. In some embodiments, a reduced-calorie partially frozen beverage may include an extract from coffee, or include coffee flavors.

In some embodiments, a consumable composition may include additives such as caffeine, coloring agents (“colorants”, “colorings”), emulsifiers, food-grade acids, minerals, micronutrients, plant extracts, preservatives, salts including buffering salts, stabilizers, thickening agents, medicaments, and a combination comprising any of the foregoing. Those of ordinary skill in the art will understand that certain additives may meet the definition or function according to more than one of the above-listed additive categories.

The pH of a partially frozen beverage, syrup or mix, or concentrate may also be modified by the addition of food-grade compounds such as ammonium hydroxide, sodium carbonate, potassium carbonate, sodium bicarbonate, and the like, and a combination comprising any of the foregoing. Additionally, the pH may be adjusted by the addition of carbon dioxide.

A person having ordinary skill in the art will understand that embodiments of partially frozen beverages may contain one or more flavors. Exemplary flavor oils may include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents may include artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, prune, raisin, cola, guarana, neroli, pineapple, apricot, banana, melon, apricot, ume, cherry, raspberry, blackberry, tropical fruit, mango, mangosteen, pomegranate, papaya and so forth. Additional exemplary flavors imparted by a flavoring agent may include a milk flavor, a butter flavor, a cheese flavor, a cream flavor, and a yogurt flavor; a vanilla flavor; tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamon flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor.

In some embodiments, other flavoring agents may include aldehydes and esters such as cinnamyl acetate, cinnamaldehyde, citral diethylacetal, dihydrocarvyl acetate, eugenyl formate, p-methylamisol, and so forth. Examples of aldehyde flavorings may include acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), and the like.

The flavoring agents may be used in liquid or solid/dried form and may be used individually or in a mixture. When employed in dried form, suitable drying means such as spray drying an oil may be used. Alternatively, the flavoring agent may be absorbed onto water-soluble materials, such as cellulose, starch, sugar, maltodextrin, gum arabic and so forth or may be encapsulated. In still other embodiments, the flavoring agent may be adsorbed onto silicas, zeolites, and the like. The techniques for preparing such dried forms are well-known.

In some embodiments, the flavoring agents may be used in many distinct physical forms. Without being limited thereto, such physical forms may include free forms, such as spray dried, powdered, beaded forms, encapsulated forms, emulsions such as caramel or gum arabic emulsions, and a combination comprising at least one of the foregoing physical forms. The particular amount of the flavoring agent effective for imparting flavor characteristics to the composition may depend upon several factors including the flavor, the flavor impression, and the like.

In some embodiments, the tartness of a beverage may be varied by selecting and combining acids to provide a desired tartness perception. Some factors to consider in determining a desired tartness include, for example, the acid's dissociation constant, solubility, pH, etc. These variables may be measured by measuring the titratable acidity of a partially frozen beverage, syrup or mix, or concentrate.

In some embodiments, a coloring agent may be used in amounts effective to produce a desired color for the composition. Exemplary coloring agents may include pigments, natural food colors and dyes suitable for food, drug and cosmetic applications. A full recitation of all colorants approved by the United States Food and Drug Administration, together with corresponding chemical structures, may be found in the Kirk-Othmer Encyclopedia of Chemical Technology, 3rd Edition, in volume 5 at pages 857-884.

As classified by the United States Food, Drug, and Cosmetic Act (21C.F.R. 73), colors may include those exempt from certification colors (sometimes referred to as natural even though they can be synthetically manufactured) and certified colors (sometimes referred to as artificial), and a combination comprising any of the foregoing. In some embodiments, exemplary colors exempt from certification or natural colors may include, for example, annatto extract, (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E 150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120); carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), and a combination comprising any of the foregoing.

In some embodiments, exemplary certified colors may include FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminum (E173), silver (E174), gold (E175), pigment rubine/lithol rubine BK (E180), calcium carbonate (E170), carbon black (E153), black PN/brilliant black BN (E151), green S/acid brilliant green BS (E142), and a combination comprising any of the foregoing. In some embodiments, certified colors may include FD&C aluminum lakes, which consist of the aluminum salts of FD&C dyes extended on an insoluble substrate of alumina hydrate. Additionally, in some embodiments, certified colors may be included as calcium salts.

In some embodiments, a consumable composition may include additional preservatives to provide freshness and to prevent the unwanted growth of bacteria, molds, fungi, or yeast. The addition of a preservative, including antioxidants, may also be used to maintain the composition's color, flavor, or texture. Exemplary preservatives may include benzoic acid alkali metal salts (e.g., sodium benzoate), sorbic acid alkali metal salts (e.g., potassium sorbate), ascorbic acid (Vitamin C), citric acid, calcium propionate, sodium erythorbate, sodium nitrite, calcium sorbate, butylated hydroxyanisole (BHA), butylated hydroxytoluene (BHT), ethylenediaminetetraacetic acid (EDTA), tocopherols (Vitamin E), straight chain polyphosphates, and a combination comprising any of the foregoing preservatives.

Syrups or mixes may be liquid or may be in the form of a powder or other solid. A syrup or mix may be in the form of a concentrate, and may, in some embodiments, be distributed with a water content that is lower than the water content present in a frozen or partially frozen beverage. In other embodiments, a syrup or mix may be shipped with ingredients at the intended concentration of the final beverage, e.g., without further dilution. Syrups or mixes may, in some embodiments, be diluted prior to use and may be shipped in one or more portions that contain the same or different compositions. In general, in this disclosure where reference is made to a reduced-calorie partially frozen beverage, a concentrate, syrup or mix, capable of forming that reduced-calorie partially frozen beverage such as, for example, by appropriate dilution or combination, is also envisioned.

### EXAMPLES

### Example 1

A cream soda flavored beverage syrup was used with conventional machinery to produce a reduced-calorie (about 120 calories per 12 oz sample) partially frozen beverage. The partially frozen beverage included about 10% solids high fructose corn syrup by weight, about 1.5% erythritol and about 35 ppm sucralose. Evaluation of the partially frozen beverage was performed using consumer testing and evaluation by a trained sensory panel. The sample was compared to a full-calorie cream soda flavored partially frozen beverage, i.e., with about 170 calories for a 12 oz sample. The reduced-calorie partially frozen beverage and the full-calorie partially frozen beverage were served blind and identified with a numerical code. Participants did not see or view the package in these tests. Participants completed a questionnaire for each product. A total of 101 consumers were used for the product testing experiments. In the questionnaire, panelists were asked to evaluate characteristics of the consumable items.

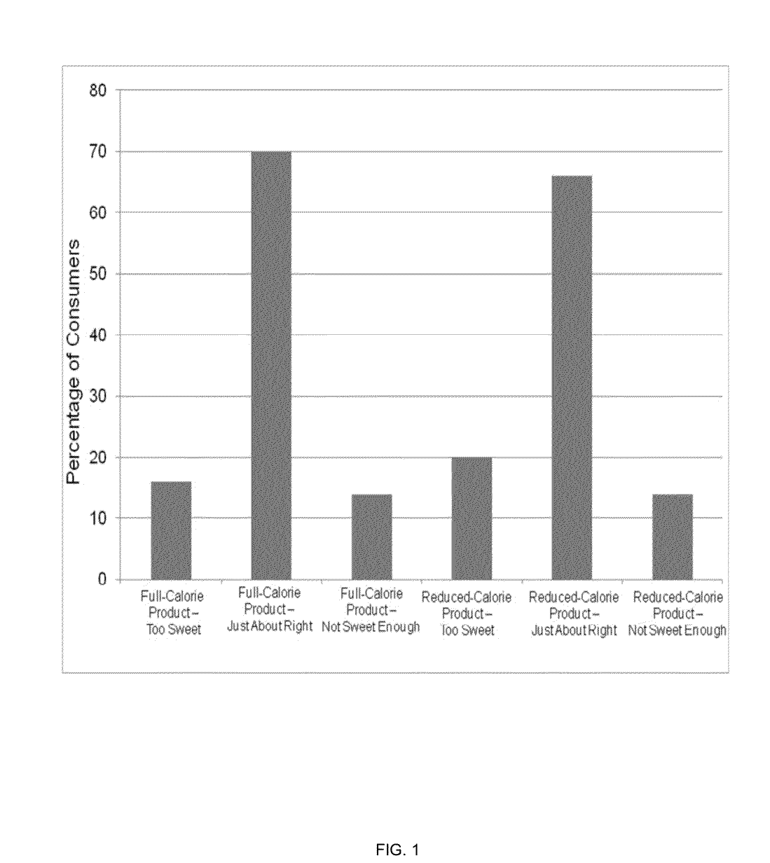

As shown in Table 1 (which data is also depicted in FIG. 1), the sweetness of the reduced-calorie partially frozen beverage was found to be similar to the full-calorie partially frozen beverage. As indicated in Table 1, about 70% of consumers found the sweetness of the full-calorie partially frozen beverage to be ideal (“just about right”) and about 66% of consumers found the sweetness of the reduced-calorie partially frozen beverage to be ideal. This difference is not significant when evaluated based on criteria established for a confidence interval of 95%.

TABLE 1

| | Full-Calorie | Reduced-Calorie |
|---|---|---|
| Sweetness of Product | Beverage (%) | Beverage (%) |
| Too sweet | 16 | 20 |
| Just about right | 70 | 66 |
| Not sweet enough | 14 | 14 |

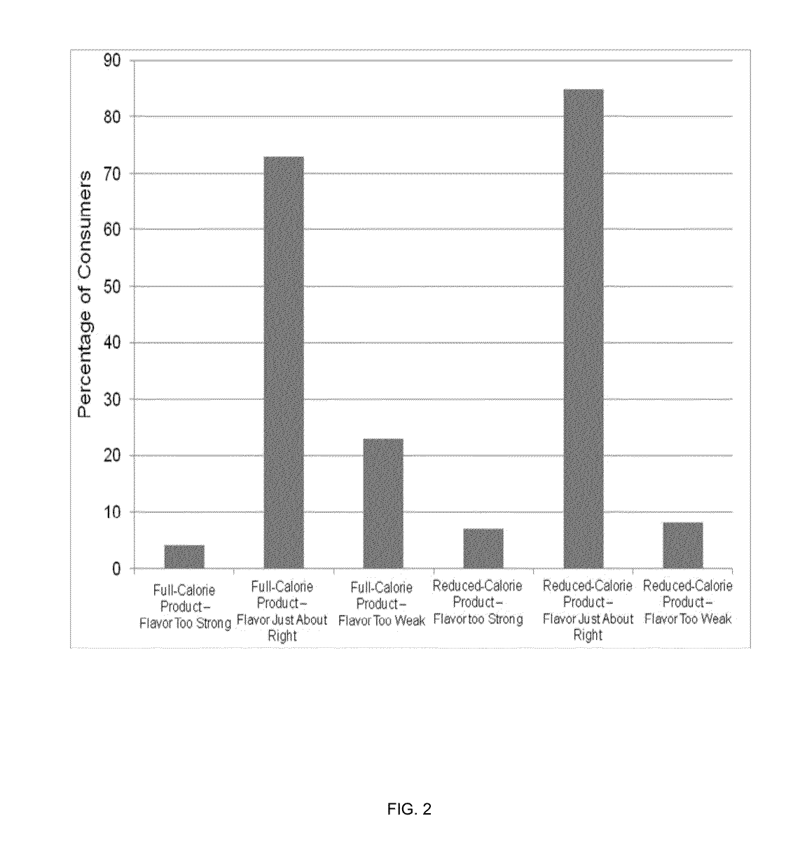

As shown in Table 2 (which data is also depicted in FIG. 2), the flavor of the reduced-calorie partially frozen beverage was found to be better than the full-calorie partially frozen beverage. As indicated in Table 2, about 73% of consumers found the flavor of the full-calorie partially frozen beverage to be ideal, and about 85% of consumers found the flavor of the reduced-calorie partially frozen beverage to be ideal. This difference is significant when evaluated based on criteria established for a confidence interval of 95%.

TABLE 2

| | Full-Calorie | Reduced-Calorie |
|---|---|---|
| Flavor of Product | Beverage (%) | Beverage (%) |
| Too strong | 4 | 7 |
| Just about right | 73 | 85 |
| Too weak | 23 | 8 |

In addition, consumers identified that texture and aftertaste of the reduced-calorie partially frozen beverage and the full-calorie partially frozen beverage were the same. That is, 50% of the consumers liked the texture of both the full-calorie and reduced-calorie partially frozen beverage, and 45% of the consumers found that both the full-calorie and reduced-calorie partially frozen beverage had no unpleasant aftertaste. The overall likeability of the reduced-calorie partially frozen beverage (47%) was better than the full-calorie partially frozen beverage (41%).

While many examples in this description refer to reduced-calorie partially frozen beverages, mixes or syrups, or concentrates, it is understood that those compositions are described in an exemplary manner only and that other compositions may be used. Additionally, other ingredients may be used, depending on the particular needs. Although the foregoing specific details describe certain embodiments, persons of ordinary skill in the art will recognize that various changes may be made in the details of these embodiments without departing from the spirit and scope of this invention as defined in the appended claims and considering the doctrine of equivalents. Therefore, it should be understood that this invention is not limited to the specific details shown and described herein.

What is claimed is:

1. A partially frozen beverage comprising:
about 0.1% to about 3.0% by weight erythritol;
about 30 to about 40 ppm sucralose; and
a sugar component.

2. The partially frozen beverage of claim 1 wherein said erythritol is between about 1% to about 2% by weight.

3. The partially frozen beverage of claim 1 wherein said erythritol is between about 1.4% to about 1.6% by weight.

4. The partially frozen beverage of claim 1 further comprising a cream soda flavor.

5. The partially frozen beverage of claim 1 wherein a total soluble solids content of said partially frozen beverage is between about 8-15% by weight.

6. The partially frozen beverage of claim 1 wherein the sugar component comprises high fructose corn syrup present at about 7.5° Bx to about 10° Bx.

7. The partially frozen beverage of claim 1 wherein the sugar component consists of glucose and fructose present at concentrations to provide a total sugar content of about 7.5° Bx to about 10° Bx.

8. The partially frozen beverage of claim 1 wherein the partially frozen beverage provides about 100 calories to about 140 calories per 12 fluid ounces.

9. The partially frozen beverage of claim 1 further comprising a cream soda, grape or orange flavor.

10. A beverage syrup, combined with water, comprising:
about 0.1% to about 3.0% by weight erythritol;
about 0 30 to about 40 ppm sucralose; and
a sugar component.

11. The beverage syrup of claim 10 wherein the beverage syrup freezes at between about 26° F. to about 30.2° F. when placed in an apparatus for production of a partially frozen beverage.

12. The beverage syrup of claim 10 wherein said erythritol is between about 1% to about 2% by weight.

13. The beverage syrup of claim 10 wherein said erythritol is between about 1.4% to about 1.6% by weight.

14. The beverage syrup of claim 10 further comprising a cream soda flavor.

15. The beverage syrup of claim 10 wherein a total soluble solids content of said beverage syrup is between about 8-15% by weight.

16. The beverage syrup of claim 10 wherein the sugar component comprises high fructose corn syrup present at about 7.5° Bx to about 10° Bx.

17. The beverage syrup of claim 10 wherein the sugar component consists of glucose and fructose present at concentrations to provide a total sugar content of about 7.5° Bx to about 10° Bx.

18. The beverage syrup of claim 11 wherein the partially frozen beverage provides about 100 calories to about 140 calories per 12 fluid ounces.

19. A partially frozen beverage consisting of:
water;
a cream soda flavor;
about 1.4% to about 1.6% by weight erythritol;
about 30 ppm to about 40 ppm sucralose; and
a sugar component.

20. The partially frozen beverage of claim 19 wherein the sugar component is about 10 weight percent high fructose corn syrup.

21. A partially frozen beverage comprising:
a sugar component;
one or more high potency sweeteners; and
less than about 2% erythritol.

22. The partially frozen beverage of claim 21 wherein the sugar component comprises a combination of fructose and one or more monosaccharides wherein the one or more monosaccharides is less sweet than fructose.

23. The partially frozen beverage of claim 22 wherein the ratio of fructose to other monosaccharides is such that the beverage total sweetness upon addition of between about 1.2% to about 1.8% erythritol and no more than 40 ppm sucralose is about that of a full-calorie beverage and the freezing point of the beverage is between about 28° F. to about 30° F.

24. The partially frozen beverage of claim 21 wherein the sugar component consists of a combination of fructose and one or more monosaccharides wherein the one or more monosaccharides is less sweet than fructose.
